(19) United States
(12) Patent Application Publication
(10) Pub. No.: US 2007/0269995 A1
(43) Pub. Date: Nov. 22, 2007

(54) Cord stopper

(76) Inventor: Yoshinobu Takahashi, Kurobe-shi (JP)

Correspondence Address: Michael S. Leonard;Everest Intellectual Property Law Group, P.O.Box 708, Northbrook, IL, 60065, US

(21) Appl. No.: 11/803,394

(22) Filed: May 14, 2007

(30) Foreign Application Priority Data
May 18, 2006 (JP) 2006-138514
Mar. 12, 2007 (JP) 2007-062044

(51) Int. Cl. H01R 11/30

(52) U.S. Cl. 439/39

(57) ABSTRACT

Provided are a main body (10) having a first cord insertion hole (11); an operating body (20) including an accommodated portion (20A) that can be accommodated in the main body (10) and a second cord insertion hole (21) that is provided to the accommodated portion (20A) and can communicate with the first cord insertion hole (11); and an elastic body (30) biasing the operating body (20) in a direction in which the first cord insertion hole (11) is displaced from the second cord insertion hole (21) and in a direction in which the operating body (20) is protruding from the main body (10), the elastic body (30) connecting the main body (10) and the operating body (20). An elastically deformable portion (26) is provided to at least one of the accommodated portion (20A) and the main body (10). The elastically deformable portion (26) is connected to the elastic body (30) and is elastically deformed at the same time when the elastic body (30) is elastically deformed.

### BACKGROUND OF THE INVENTION

1. Field of the Invention

The present invention relates to a cord stopper attached to a cord, the cord stopper adjusting a tightening state or a length of a cord attached to a garment, a hat, a bag, a tent, a backpack and the like.

2. Description of Related Art

An adjusting and securing member disclosed in JP-A-S63-272302 has been known as a cord stopper that adjusts a tightening state or a length of a cord attached to a garment, a hat, a bag, a tent, a backpack and the like.

The adjusting and securing member disclosed in the document are integrally formed by a box-like outer cylinder with openings in an upper surface and lateral surfaces of the outer cylinder, a sliding member accommodated in the outer cylinder such that a portion of the sliding member is protruding from the opening in the upper surface, and a spring member that is accommodated in an inner bottom surface of the outer cylinder and biases the sliding member in a direction toward the outside of the outer cylinder. The outer cylinder and the sliding member each have a cord hole.

When the sliding member is pressed into the outer cylinder against the spring member, the cord holes of the outer cylinder and the sliding member communicate with each other (i.e. the holes are in coincident with each other), so that a cord can be threaded through the cord holes. When the pressing is stopped, the sliding member is returned to an original position by the cord member. Accordingly, the cord hole of the outer cylinder and the cord hole of the sliding member are displaced from each other, thereby holding the cord.

Since the adjusting and securing member disclosed in the document has an arrangement in which the outer cylinder has the cord hole and the inner bottom surface of the outer cylinder accommodates the spring member that biases the sliding member in the direction toward the outside of the outer cylinder, a dimension in a cylindrical direction of the outer cylinder (a dimension in a sliding direction of the sliding member) becomes large.

Accordingly, when attached to the cord, the outer cylinder widely protrudes in a direction orthogonal to a longitudinal direction of the cord. Hence, such a protruding portion may touch something or be caught in something, which may cause damage on the adjusting and securing member or on the thing. In addition, appearance of the adjusting and securing member may be degraded.

In order to shorten the dimension in the sliding direction of the sliding member, in the document, the adjusting and securing member may employ an arrangement for reducing an amount of elastic deformation of the spring member such as shortening a length of the spring member and decreasing the length of the spring member while increasing a thickness of the spring member. However, such arrangements may weaken a holding force relative to the cord. Or in trying to ensure the holding force, rigidity of the spring member may be too strong, so that a connecting portion of the spring member and the outer cylinder may split.

### SUMMARY OF THE INVENTION

An object of the present invention is to provide a cord stopper that has a reduced dimension of an operating body in an operation direction while ensuring a holding force relative to a cord.

A cord stopper of according to an aspect of the invention includes: a main body including a first cord insertion hole; an operating body including: an accommodated portion that can be accommodated in the main body; and a second cord insertion hole that is provided to the accommodated portion and can communicate with the first cord insertion hole; and an elastic body that connects the main body and the operating body and biases the operating body in a direction in which the first cord insertion hole is displaced from the second cord insertion hole and in a direction in which the operating body protrudes from the main body. The accommodated portion is connected to the elastic body. An elastically deformable portion is provided to at least one of the accommodated portion and the main body, the elastically deformable portion being elastically deformable at the same time when the elastic body is elastically deformed.

Herein, the accommodated portion of the operating body is a portion to be accommodated in the main body when the operating body is inserted in the main body against a biasing force of the elastic body. The accommodated portion may be a portion of the operating body or the whole of the operating body.

In the arrangement, a cord is released from a held state by the first and second cord insertion holes when the operating body is inserted in the main body against the biasing force of the elastic body and the second cord insertion hole provided to the accommodated portion is brought into communication with the first cord insertion hole of the main body. In this state, by sliding the cord relative to the cord stopper to a certain position or by sliding the cord stopper relative to the cord to a certain position, the insertion of the operating body is released. Accordingly, the operating body is protruded from the main body by the biasing force of the elastic body and the first and second cord holes are displaced from each other, so that the cord inserted in these holes is sandwiched and held by the first and second cord insertion holes.

The elastically deformable portion that is connected to the elastic body and can be elastically deformed at the same time when the elastic body is elastically deformed is provided to at least one of the accommodated portion and the main body. Hence, when the operating body is inserted in the main body against the biasing force of the elastic body, the elastically deformable portion is elastically deformed at the same time when the elastic body is elastically deformed. In other words, not only the elastic body but also at least one of the accommodated portion and the main body can have elastic deformability, so that the holding force relative to the cord will not be reduced even when a length of the elastic body is extremely small. Hence, a dimension of the operating body in the operation direction can be small while ensuring the holding force relative to the cord.

In the cord stopper according to the aspect of the invention, the accommodated portion may include a cord accommodating portion that accommodates a cord.

In the arrangement, the cord can be guided by the cord accommodation portion provided to the accommodated portion, thereby reliably holding the cord.

In the cord stopper according to the aspect of the invention, the accommodated portion may be provided with the accommodated-portion-side elastically deformable portion such that the accommodated-portion-side elastically deformable portion continuously extends from a protruding end surface of the operating body, the protruding end surface of the operating body protruding from the main body.

In the arrangement, the accommodated portion is provided with the accommodated-portion-side elastically deformable portion continuously extending from the protruding end surface of the operating body, the protruding end surface of the operating body protruding from the main body, so that even a portion of the operating body can have great elastic deformability.

In the cord stopper according to the aspect of the invention, the elastic body may be elastically deformed in a direction in which the operating body moves, and the accommodated-portion-side elastically deformable portion may be elastically deformed in a different direction from that of the elastic body.

Especially, in the cord stopper according to the aspect of the invention, the accommodated-portion-side elastically deformable portion may be elastically deformed in an expanding direction when an external force is applied on the operating body.

In the arrangement, when an external force is applied on the operating body, the accommodated-portion-side elastically deformable portion is elastically deformed in a direction different from that of the elastic body such as a direction in which the operating body expands. The operating body expands while decreasing its size in the operation direction. Hence, the dimension of the operating body in the operation direction can be small.

In the cord stopper according to the aspect of the invention, the main body may be provided with a first opening for accommodating the operating body in the main body, and a wall facing the first opening may be provided with a second opening for accommodating the elastic body in the main body.

In the arrangement, when the operating body is inserted in the main body, the elastic body is elastically deformed while being accommodated through the second opening. Specifically, since a relief space for accommodating the elastic body is provided in the wall of the main body, the dimension of the operating body in the operation direction can be further smaller.

In the cord stopper according to the aspect of the invention, the main body may be provided with the main-body-side elastically deformable portion that can be elastically deformed in a direction in which the second opening expands when the elastic body is elastically deformed, the main-body-side elastically deformable portion disposed in the vicinity of a connecting portion of the elastic body.

In the arrangement, the main-body-side elastically deformable portion is provided to the main body in the vicinity of the connecting portion to which the elastic body is connected, the main body also can have great elastic deformability.

In the cord stopper according to the aspect of the invention, the main body may include: a first wall in which the first opening is formed; a second wall in which the second opening is formed; and a pair of third walls that faces each other and connects the first wall and the second wall, the main body formed in a cylindrical shape having the first cord insertion hole inside. Each of the pair of third walls may be provided with a slit of which one end reaches the second opening and the other end is near the first opening, the slit formed on a connecting portion side of the elastic body in a hole direction of the first cord insertion hole. A division on the connecting portion side of the elastic body out of the pair of third walls divided by each slit may be provided as the main-body-side elastically deformable portion.

In the arrangement, the third wall of the main body is divided by the slit and the division on the connecting portion side of the elastic body out of the divided third wall is formed as the main-body-side elastically deformable portion, so that an elastic piece is elastically deformed when the operating body is inserted in the main body for adjusting the length of the cord. Accordingly, the division on the connecting portion side of the elastic piece (the main-body-side elastically deformable portion) out of the third wall divided by the slit is deformed relative to the other division, so that the main-body-side elastically deformable portion can be provided by a comparatively simple arrangement. In addition, since the division on the connecting portion side of the elastic piece (the main-body-side elastically deformable portion) is deformed, force concentrated on the connecting portion of the elastic body can be dispersed by the division (the main-body-side elastically deformable portion) when the operating body is inserted in the main body. Thereby, damage on the connecting portion of the pair of elastic pieces can be avoided.

In the cord stopper according to the aspect of the invention, the slit may be provided in each of the pair of third walls that faces each other such that each slit is diagonal to each other.

In the arrangement, since the slits are provided substantially at diagonal positions on the pair of facing third walls, the elastic deformability can be ensured while ensuring the strength of the main body.

In the cord stopper according to the aspect of the invention, the elastic body may be provided between a wall portion of the main body and an end surface opposite to a protruding end surface of the operating body, the protruding end surface of the operating body protruding from the main body, the wall portion facing the end surface. The elastic body may include an elastic piece provided so as to be slant as extending from the wall portion of the main body to the operating body.

In the arrangement, the elastic body is provided between the main body and the operating body and is formed by the elastic pieces provided so as to be slant as extending from the main body to the operating body, so that the length of the elastic piece can be maximum in the space between the main body and the operating body. Hence, great elastic deformability can be ensured by a small space.

In the cord stopper according to the aspect of the invention, the elastic body may be provided between a wall portion of the main body and an end surface opposite to a protruding end surface of the operating body, the protruding end surface of the operating body protruding from the main body, the wall portion facing the end surface. The elastic body may include a pair of elastic pieces provided so as to extend from remote positions on the wall portion of the main body, to approach to each other as extending toward the operating body, to intersect each other and to further extend while becoming farther from each other.

In the arrangement, the elastic body is formed by the pair of elastic pieces that extends obliquely and intersects each other, the elastic body disposed between the main body and the operating body, so that the operating body can be inserted with a strong holding force and in a stable posture into a protruding state when the operating body is inserted in the main body or protruded from the main body for adjusting the length of the cord.

In the cord stopper according to the aspect of the invention, the accommodated-portion-side elastically deformable portion may be formed by a plurality of divisions into which the accommodated portion is divided in a hole direction of the second cord insertion hole by slits having a depth reaching the second cord insertion hole. The elastic piece may be connected to at least one of the divisions.

In the arrangement, the accommodated-portion-side elastically deformable portion is formed by the plurality of divisions divided by the slits and the elastic piece is connected to at least one division of the divisions. Accordingly, when the operating body is inserted in the main body for adjusting the length of the cord, the elastic piece is elastically deformed. Then, the one division of the accommodated-portion-side elastically deformable portion to which the elastic piece is connected is deformed relative to the other division, so that the main-body-side elastically deformable portion can be provided by a comparatively simple arrangement. In addition, the accommodated-portion-side elastically deformable portion can be elastically deformed at the same time when the elastic piece is elastically deformed in conjunction.

A cord stopper according to an aspect of the invention includes: a main body having a first cord insertion hole; an operating body accommodated in the main body; and an elastic body biasing the operating body in a direction in which the operating body is protruded from the main body. The main body and the operating body are connected each other by the elastic body (30). The main body includes at least one opening that is in communication with the first cord insertion hole. The operating body includes a second cord insertion hole that can communicate with the first cord insertion hole and an. accommodated-portion-side elastically deformable portion that is provided to the second cord insertion hole and connected to the elastic body, the accommodated-portion-side elastically deformable portion being elastically deformable at the same time when the elastic body is elastically deformed. The accommodated-portion-side elastically deformable portion is formed by a plurality of divisions into which the second cord insertion hole is divided in a hole direction of the second cord insertion hole by slits having a depth enough to reach the second cord insertion hole. The elastic body is provided between a wall portion of the main body and an end surface opposite to a protruding end surface of the operating body, the protruding end surface of the operating body protruding from the main body, the wall portion facing the end surface. The elastic body includes a pair of elastic pieces provided so as to extend from remote positions on the wall portion of the main body, approach to each other as extending toward the operating body (20). Tip ends of the elastic pieces are connected with at least one of the divisions out of the divisions.

In the arrangement, in addition to the above-described advantages, the number of components can be reduced since the main body, the operating body and the elastic body are integrally formed. Hence, it is possible to reduce the numbers of manufacturing processes and assembling processes, thereby reducing the costs.

In the cord stopper according to the aspect of the invention, the main body may include: a first wall; a second wall facing the first wall; and a pair of third walls that faces each other and connects the first wall and the second wall, the main body formed in a cylindrical shape having the first cord insertion hole inside. The first wall may be provided with a first opening for accommodating the operating body in the main body. The second wall may be provided with a second opening for accommodating the elastic body in the main body. Each of the pair of third walls may be provided with a slit of which one end reaches the second opening and the other end is near the first opening, the slit formed on the connecting portion side of the elastic body in a hole direction of the first cord insertion hole. A division on the connecting portion side of the elastic body out of the pair of third walls divided by the slit may be provided as a main-body-side elastically deformable portion that can be elastically deformed at the same time when the elastic body is elastically deformed.

In the arrangement, since not only the accommodated-portion-side elastically deformable portion but also the main-body-side elastically deformable portion can be elastically deformed, great elastic deformability can be ensured. As a result, the dimension of the operating body in the operation direction can be minimized while ensuring the holding force relative to the cord.

### BRIEF DESCRIPTION OF THE DRAWINGS

FIG. 1 is a perspective view of a cord stopper of a first embodiment of the invention;

FIG. 2 is a front view of the cord stopper of the first embodiment;

FIG. 3 is a bottom plan view of the cord stopper of the first embodiment;

FIG. 4 is a cross section of the cord stopper of the first embodiment (a cross section taken along IV-IV line in FIG. 3);

FIG. 5 is a cross section showing a state in which an operating body is inserted from a state shown in FIG. 4 into a main body;

FIG. 6 is a cross section showing a state in which the operating body is released from the inserted state shown in FIG. 5;

FIG. 7 is a cross section of a cord stopper of a second embodiment of the invention;

FIG. 8 is a perspective view showing a cord stopper of a third embodiment of the invention;

FIG. 9 is a front view of the cord stopper of the third embodiment;

FIG. 10 is a cross section of a cord stopper of a fourth embodiment of the invention;

FIG. 11 is a cross section of a cord stopper of a fifth embodiment of the invention;

FIG. 12 is a perspective view of the cord stopper of the fifth embodiment;

FIG. 13 is a perspective view of a cord stopper of a sixth embodiment of the invention;

FIG. 14 is a front view of the cord stopper of the sixth embodiment;

FIG. 15 is a bottom plan view of the cord stopper of the sixth embodiment;

FIG. 16 is a front view showing how the cord stopper of the sixth embodiment works (how an elastically deformable portion works);

FIG. 17 is a bottom plan view showing how the cord stopper of the sixth embodiment works (how the elastically deformable portion works); and

FIG. 18 is a front view of a cord stopper of a seventh embodiment of the invention.

### DETAILED DESCRIPTION OF PREFERRED EMBODIMENT(S)

Embodiments of the present invention will be described below with reference to the drawings.

### First Embodiment

### (Arrangements)

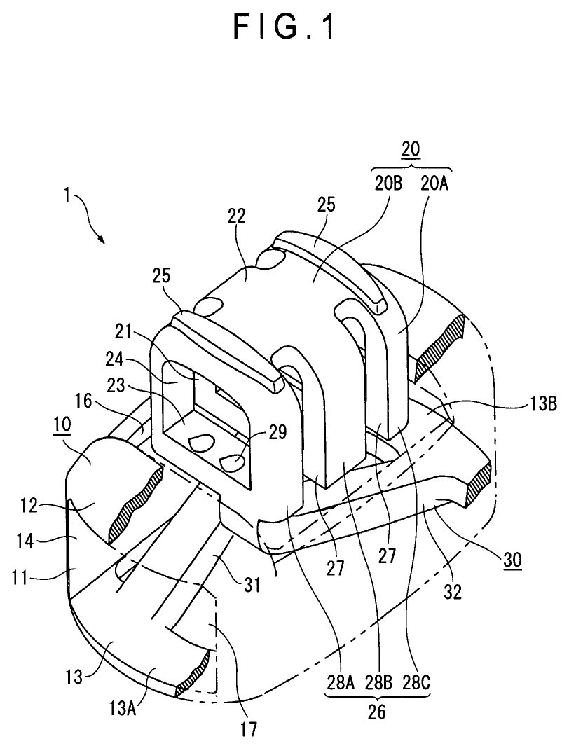

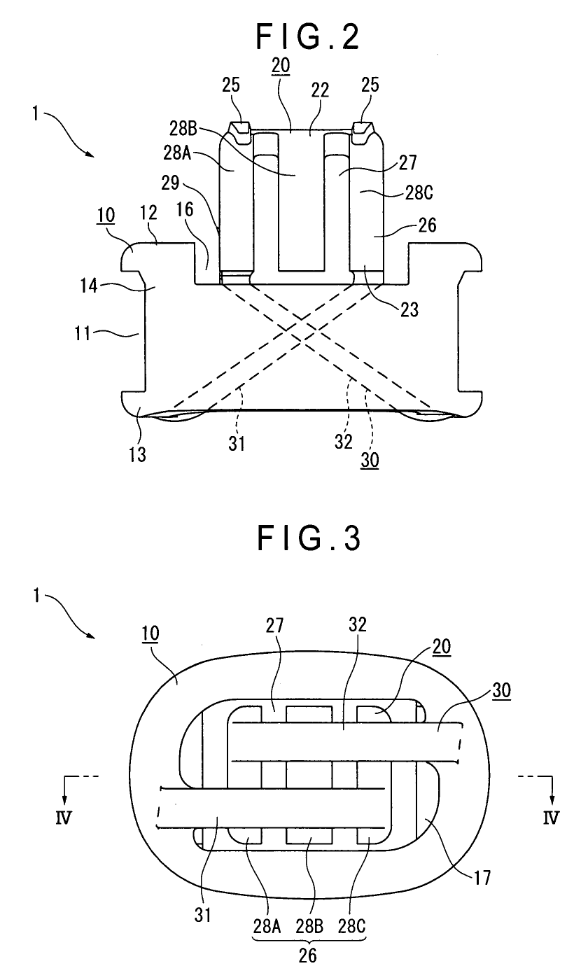

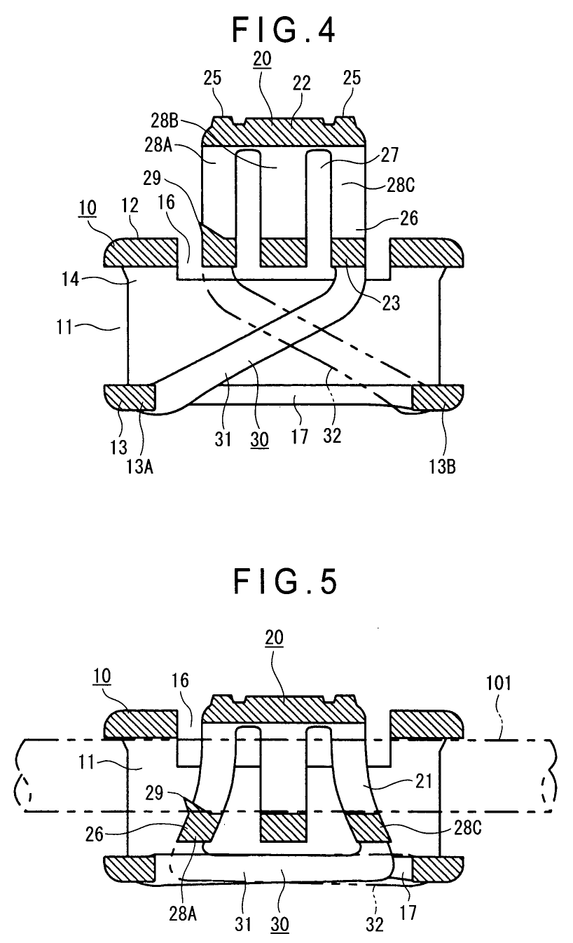

A cord stopper according to a first embodiment is illustrated in FIGS. 1 to 6. FIG. 1 is an exploded perspective view of a cord stopper 1. FIG. 2 is a front view of the cord stopper 1. FIG. 3 is a bottom plan view of the cord stopper 1. FIGS. 4 to 6 each are a cross section explaining an effect of the cord stopper 1.

As shown in FIGS. 1 to 3, the cord stopper 1 of the first embodiment includes a main body 10, an operating body 20 accommodated in the main body 10 and an elastic body 30 biasing the operating body 20 in a direction in which the operating body 20 protrudes from the main body 10.

The main body 10 and the operating body 20 are connected by the elastic body 30. The main body 10, the operating body 20 and the elastic body 30 are integrally formed from resin or the like. For example, the main body 10, the operating body 20 and the elastic body 30 may be an integral molding formed by injection compression molding from a comparatively hard resin material such as polyacetal, polyamide, polypropylene, ABS (acrylonitrile butadiene styrene) resin, polycarbonate.

The main body 10 has a first cord insertion hole 11 penetrating inside the main body 10, so that the main body 10 has a cylindrical shape. The main body 10 has a substantially cylindrical rectangular shape through which the first cord insertion hole 11 in a substantially rectangular shape in cross section penetrates.

Facing walls of circumferential walls of the rectangular cylindrical shape i.e. an upper wall 12 and a lower wall 13 respectively have a first opening 16 and a second opening 17 which communicate with the first cord insertion hole 11.

The first opening 16 enables the operating body 20 to be accommodated in the main body 10, the first opening 16 formed in a rectangular shape extending from the center of the upper wall 12 of the main body 10 toward lateral walls 14. The second opening 17 enables the elastic body 30 to be accommodated, the second opening 17 formed substantially in a rectangular shape at a central portion of the lower wall 13 of the main body 10.

The operating body 20 includes: an accommodated portion 20A that has a size to be accommodated in the main body 10 (in the first cord insertion hole 11) from the first opening 16 of the main body 10, the accommodated portion 20A accommodated in the main body 10 (in the first cord insertion hole 11) from the first opening 16; and an operated portion 20B provided on a protruding end side of the accommodated portion 20A from the main body 10. Herein, the accommodated portion 20A is a portion to be accommodated in the main body 10 when the operating body 20 is inserted in the main body 10 against a biasing force of the elastic body 30. In the first embodiment, the accommodated portion 20A is the operating body 20 excluding an upper wall 22 but may be at least a portion of the operating body 20 or the whole of the operating body 20.

The accommodated portion 20A has a cylindrical shape in which a second cord insertion hole 21 penetrates, the second cord insertion hole 21 communicatable with the first cord insertion hole 11 of the main body 10. Specifically, the accommodated portion 20A is formed in a substantially rectangular shape through which the second cord insertion hole 21 in a substantially rectangular shape in cross section penetrates. An accommodated-portion-side elastically deformable portion 26 is formed in at least a portion of lateral walls 24 out of circumferential walls of the rectangular cylindrical shape, the lateral walls 24 extending in moving directions of the operating body 20. The accommodated-portion-side elastically deformable portion 26 can be elastically deformed at the same time when the elastic body 30 is elastically deformed.

The accommodated portion 20A is divided in a hole direction of the second cord insertion hole 21 into three divisions 28A, 28B and 28C. The accommodated portion 20A is divided in a manner that a lower wall 23 and the lateral walls 24 of the operating body 20 are divided by two slits 27 having a depth reaching the second cord insertion hole 21. The elastic body 30 is connected with the lower wall 23 with a predetermined angle. The accommodated-portion-side elastically deformable portion 26 is formed by the divisions 28A and 28C on both ends. Accordingly, the two divisions 28A and 28C can be elastically deformed in directions different from directions in which the elastic body 30 is elastically deformed. In other words, the divisions 28A and 28C can be elastically deformed in directions substantially orthogonal to the moving directions of the operating body 20. More specifically, the divisions 28A and 28C can be elastically deformed in the hole direction of the second cord insertion hole 21 i.e. in directions in which the slits 27 widen.

Two holding projections 29 that hold the cord are provided in the second cord insertion hole 21 and on the division 28A on an outer side out of the three divisions 28A, 28B and 28C. The holding projections 29 are aligned in a width direction in parallel to each other. In other words, the holding projections 29 are provided to the accommodated-portion-side elastically deformable portion 26 of the operating body 20. The holding projections 29 each have a conical shape of which diameter of the holding projection 29 becomes smaller as being closer to a tip end of the conical shape. The holding projections 29 each project in an outward oblique and upward direction of the second cord insertion hole 21 (an upward left direction in FIG. 2) as being closer to the middle of the second cord insertion hole 21.

The operated portion 20B is formed by the upper wall 22 of the operating body 20, the upper wall 22 protruding from the first opening 16 of the main body 10. Two finger placing bars 25 are integrally formed on a top surface of the upper wall 22 of the operating body 20 such that the two finger placing bars are orthogonal to the hole direction of the second cord insertion hole 21. The finger placing bars 25 are remote from each other in the hole direction of the second cord insertion hole 21.

The elastic body 30 includes a pair of elastic pieces 31 and 32 provided between the lower wall 13 of the main body 10 and an end surface opposite to a protruding end surface of the operating body 20, the protruding end surface of the operating body 20 protruding from the main body 10, the lower wall 13 facing the end surface. The pair of elastic pieces 31 and 32 extends from positions that are remote from each other and on the lower wall 13 of the main body 10. Specifically, the pair of elastic pieces 31 and 32 respectively extends from inner ends of lower wall connecting pieces 13A and 13B that are apart from each other with the second opening 17 therebetween. The pair of elastic pieces 31 and 32 extends toward the operating body 20 while becoming closer to each other and intersects. The pair of elastic pieces 31 and 32 further extends while becoming farther from each other. In other words, the pair of elastic pieces 31 and 32 is provided in a slant manner, forming an X shape. Tip ends of the pair of elastic pieces 31 and 32 are each connected in a nonlinear manner with a predetermined angle to the two divisions 28A and 28C out of the three divisions 28A, 28B and 28C which form the accommodated-portion-side elastically deformable portion 26, the two divisions 28A and 28C having a largest distance therebetween. Root portions of the pair of elastic pieces 31 and 32 are formed so as to have a larger thickness than that of the lower wall connecting pieces 13A and 13B.

### (Effects)

In a state shown in FIG. 4, a finger is placed on a top surface of the operating body 20 and the operating body 20 is inserted in the main body 10 against the biasing force of the elastic body 30. Herein, since the two finger placing bars 25 are provided on the upper wall 22 of the operating body 20, the finger placed on the top surface of the operating body 20 is less likely displaced in an inadvertent manner, thereby enabling a user to conduct an inserting operation in a reliable manner.

When the operating body 20 is in the main body 10, a downward force is applied on the pair of elastic pieces 31 and 32 of the elastic body 30 especially on the root portions of the pair of elastic pieces 31 and 32 (the connecting portions with the lower wall connecting pieces 13A and 13B). However, since the root portions of the pair of elastic pieces 31 and 32 are formed thick, stress will not concentrate on the root portions, so that damage during use can be prevented for a long time. On the contrary, since the root portions of the pair of elastic pieces 31 and 32 are formed thick and extend from lateral walls of the lower wall connecting pieces 13A and 13B i.e. extend from inner walls of the second opening 17, the force applied on the root portions of the pair of elastic pieces 31 and 32 may cause a torsion in the lower wall connecting pieces 13A and 13B, thereby facilitating elastic deformation of the pair of elastic pieces 31 and 32.

When the operating body 20 is inserted to a state shown in FIG. 5, the pair of elastic pieces 31 and 32 is deformed and the accommodated-portion-side elastically deformable portion 26 of the operating body 20 is also deformed in directions different from those of the elastic body 30. Specifically, since the pair of elastic pieces 31 and 32 is integrally connected with the accommodated-portion-side elastically deformable portion 26 with a predetermined angle, the pair of elastic pieces 31 and 32 is elastically deformed into a horizontal posture in the directions in which the operating body 20 is moved and the divisions 28A, 28C on the outer sides out of the divisions 28A, 28B and 28C of the accommodated-portion-side elastically deformable portion 26 are deformed by expanding in directions apart from each other. Thereby, not only the pair of elastic pieces 31 and 32 but also the operating body 20 can have elastic deformability and large stress applied on the connecting portions where the pair of elastic pieces 31 and 32 is connected with the accommodated-portion-side elastically deformable portion 26 and the lower wall 13 can be reduced. Accordingly, even when a length of the pair of elastic pieces 31 and 32 is adapted to be extremely short, the holding force relative to the cord will not be deteriorated. Hence, a dimension of the operating body 20 in the operation direction can be small while ensuring the holding force relative to the cord.

In the state shown in FIG. 5, the pair of elastic pieces 31 and 32 of the elastic body 30 is elastically deformed in a horizontal posture and accommodated in the second opening 17 while keeping the horizontal posture. Accordingly, since a space for accommodating the pair of elastic pieces 31 and 32 is provided in a lower wall 13 portion of the main body 10 (the second opening 17), the dimension of the operating body 20 in the operation direction can be extremely small.

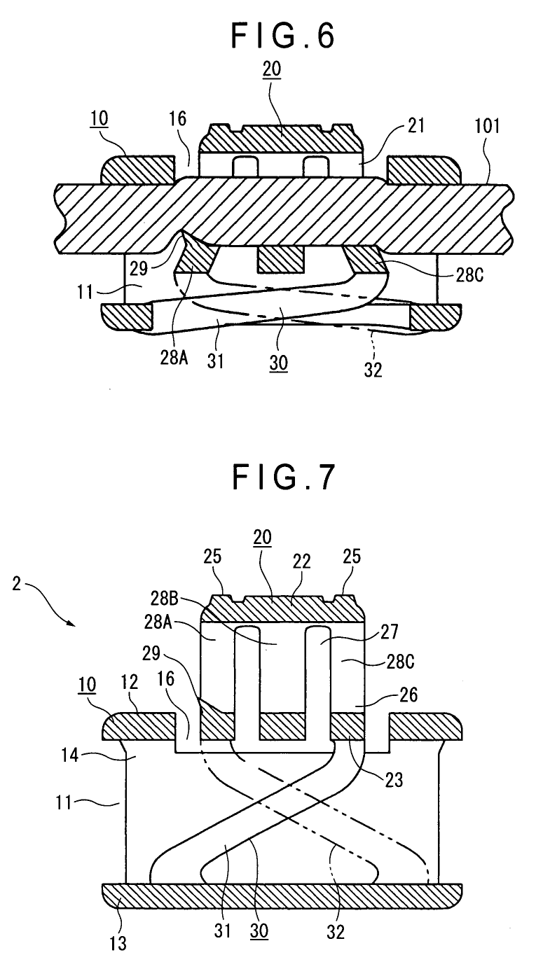

The second cord insertion hole 21 of the operating body 20 is substantially brought into coincidence with the first cord insertion hole 11 of the main body 10. A cord 101 is inserted through the first cord insertion hole 11 and the second cord insertion hole 21 and the cord stopper 1 is slid to a predetermined position of the cord 101. Then, the insertion of the operating body 20 is released. As shown in FIG. 6, the operating body 20 is protruded from the main body 10 by the biasing force of the pair of elastic pieces 31 and 32, so that the first cord insertion hole 11 and the second cord insertion hole 21 are displaced from each other. Hence, the cord 101 is sandwiched and held by the first cord insertion hole 11 and the second cord insertion hole 21.

Herein, the holding projections 29 provided in the second cord insertion hole 21 bite into the cord 101, so that the cord stopper 1 can be reliably secured to the cord 101. In addition, since the projecting direction of the holding projections 29 is inclined relative to the longitudinal direction of the cord 101, the biting force into the cord can have an orientation, thereby more reliably securing the cord 101. In the first embodiment, since the projecting direction of the holding projections 29 is left oblique and upward direction in FIGS. 4 to 6, the cord 101 will not be disengaged by a tensile force toward the right.

### Second Embodiment

A second embodiment of the invention will be shown in FIG. 7. FIG. 7 is a cross section of a cord stopper 2 of the second embodiment.

The cord stopper 2 of the second embodiment differs from the cord stopper 1 of the first embodiment in the following point.

Although the main body 10 of the first embodiment is provided with the second opening 17, the main body 10 of the second embodiment is provided with no second opening and the pair of elastic pieces 31 and 32 is integrally formed so as to extend from an inner surface of the lower wall 13 of the main body 10. Hence, the dimension of the operating body 20 in the operation direction is slightly larger than that of the first embodiment and strength of the main body 10 of the second embodiment is larger than that of the first embodiment (i.e. the main body 10 has a higher rigidity in the second embodiment).

### Third Embodiment

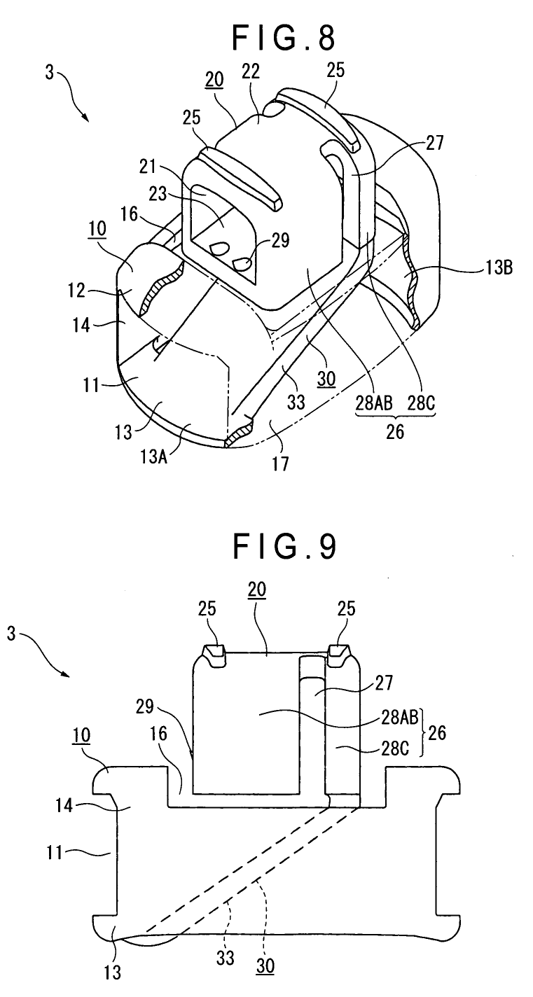

A third embodiment of the invention will be shown in FIGS. 8 and 9. FIG. 8 is a perspective view of a cord stopper 3 of the third embodiment. FIG. 9 is a front view of the cord stopper 3.

The cord stopper 3 of the third embodiment differs from the cord stopper 1 and 2 of the first and second embodiments in points in which the elastic body 30 is formed only by one elastic piece and in which the accommodated-portion-side elastically deformable portion 26 of the operating body 20 is formed only by two divisions.

In the cord stopper 3 of the third embodiment, an elastic piece 33 of the elastic body 30 has a substantially common width to that of the operating body 20, the elastic piece 33 extending from one end of the lower wall 13 of the main body 10 (i.e. from one inner end of the second opening 17) toward the other end of the lower wall 23 of the operating body 20. The accommodated-portion-side elastically deformable portion 26 of the operating body 20 is divided by one slit 27 into two divisions 28AB and 28C. A tip end of the elastic piece 33 is connected to the division 28C. The division 28AB has a size equal to a combined size of the divisions 28A and 28B of the first embodiment.

Note that one elastic piece may be provided like in the third embodiment but three or more elastic pieces may be alternatively provided.

### Fourth Embodiment

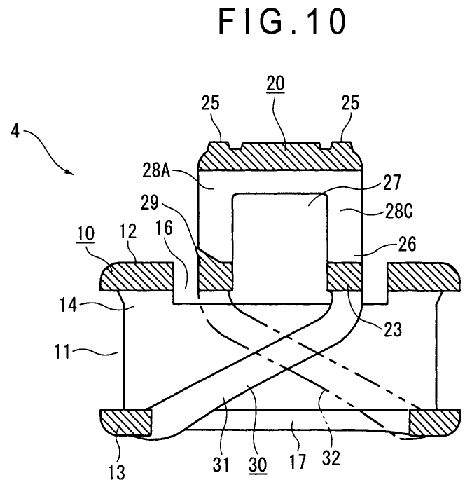

A fourth embodiment of the invention will be shown in FIG. 10. FIG. 10 shows a cross section of a cord stopper 4 of the fourth embodiment.

The cord stopper 4 of the fourth embodiment is the cord stopper 1 of the first embodiment with the division 28B in the middle out of the three divisions 28A, 28B and 28C of the accommodated-portion-side elastically deformable portion 26 of the operating body 20 omitted. The accommodated-portion-side elastically deformable portion 26 is formed by two divisions 28A and 28C which are remote from each other, so that a length of the cord stopper in a direction in which the cord is inserted can be small.

### Fifth Embodiment

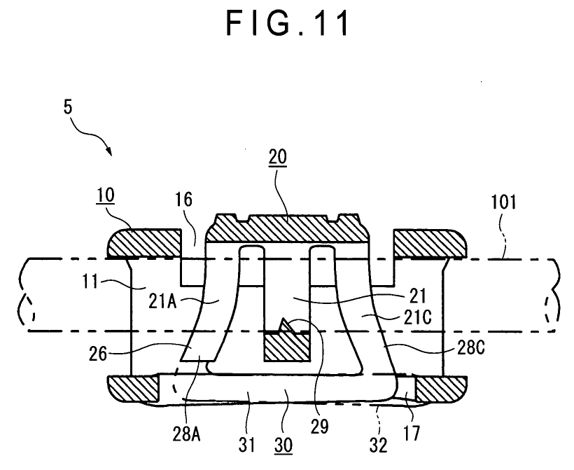

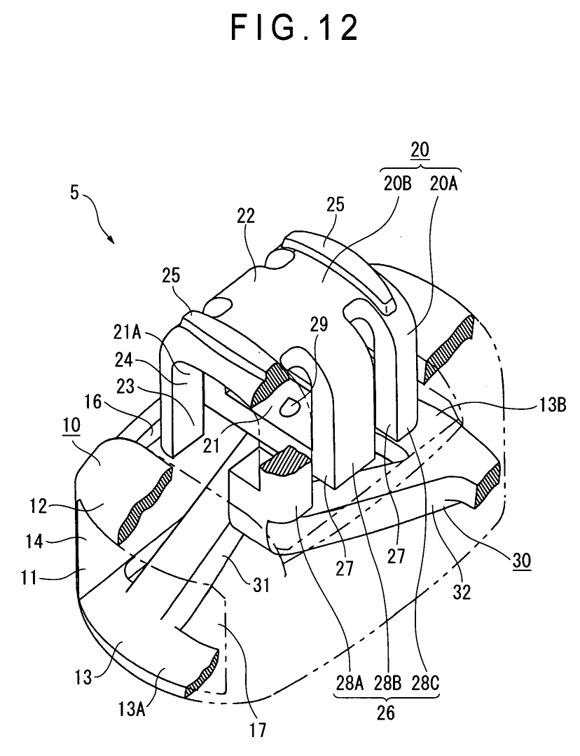

A fifth embodiment of the invention will be shown in FIGS. 11 and 12. FIG. 11 shows a cross section of a cord stopper 5 of the fifth embodiment. FIG. 12 is a perspective view of the cord stopper 5.

The cord stopper 5 of the fifth embodiment is the cord stopper 1 of the first embodiment with the lower wall 13 of the divisions 28A and 28C on the outer sides out of the three divisions 28A, 28B and 28C of the accommodated-portion-side elastically deformable portion 26 of the operating body 20 omitted. Accordingly, the second cord insertion hole 21 is formed only in the division 28B in the middle. In the divisions 28A and 28C on the outer sides, spaces function as cord accommodating portions 21A and 21C for accommodating the cord. Accordingly, the cord accommodating portions 21A and 21C can guide the cord to the second cord insertion hole 21, thereby reliably holding the cord. The holding projection 29 is provided on an inner surface of the lower wall 23 of the division 28B in the middle.

### Sixth Embodiment

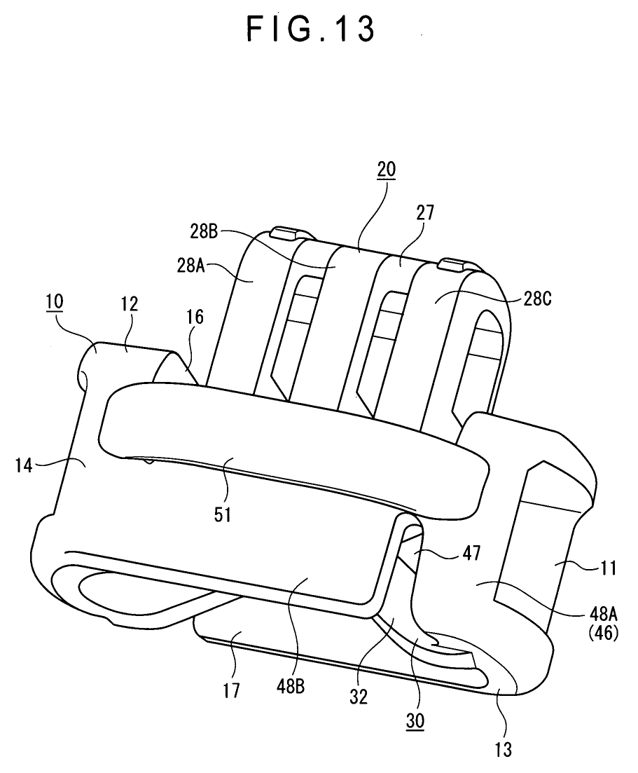

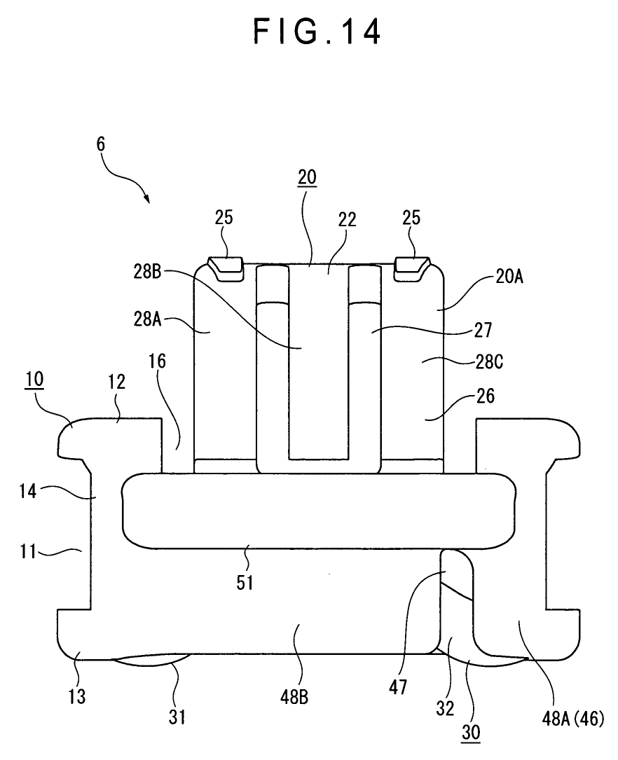

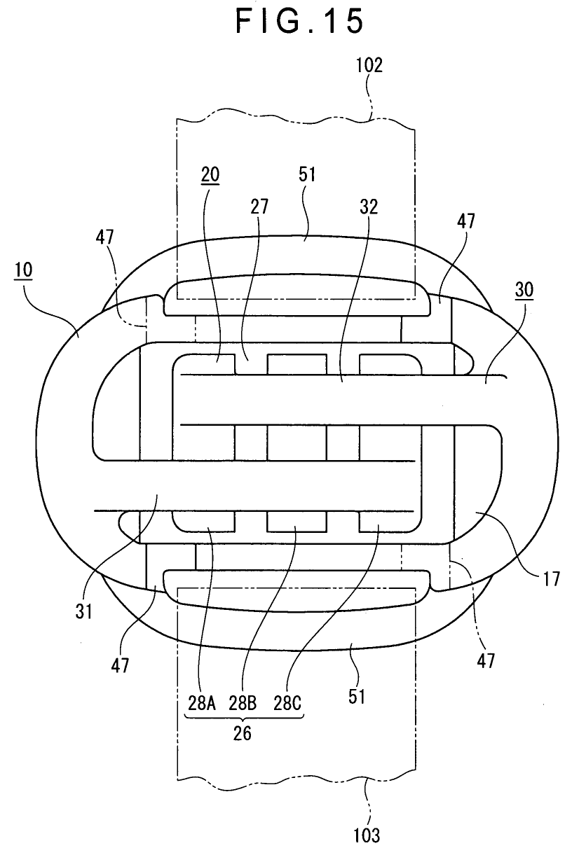

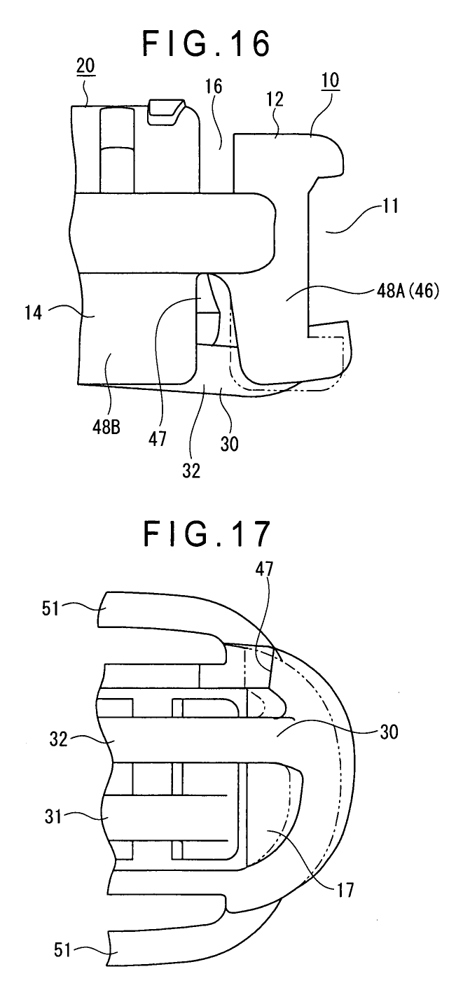

A sixth embodiment of the invention will be shown in FIGS. 13 to 17. FIG. 13 is a perspective view of a cord stopper 6 of the sixth embodiment. FIG. 14 is a front view of the cord stopper 6. FIG. 15 is a bottom plan view of the cord stopper 6. FIGS. 16 and 17 each explain an effect of the cord stopper 6.

The cord stopper 6 of the sixth embodiment differs from the cord stopper 1 of the first embodiment in points in which the accommodated portion 20A of the operating body 20 and the main body 10 is each provided with the elastically deformable portion and in which a pair of lateral walls 14 of the main body 10 is provided with a cord through bar 51.

Specifically, the main body 10 includes the upper wall 12 as a first wall on which the first opening 16 is formed, the lower wall 13 as a second wall on which the second opening 17 is formed and the lateral walls 14 as a pair of third walls which faces each other and connects the upper wall 12 with the lower wall 13. The main body 10 has a cylindrical shape having the first cord insertion hole 11 inside. The pair of facing lateral walls 14 is provided with a slit 47. The slit 47 has a length such that one end reaches the second opening 17 and the other end does not reach but is near the first opening 16. The slit 47 is formed so as to be displaced on the connecting portion side of the pair of elastic pieces 31 and 32 which is next to each other in the hole direction of the first cord insertion hole 11. In other words, the slit 47 is provided at substantially diagonal positions of the pair of facing lateral walls 14. Out of the lateral wall 14 divided by the slit 47, a division 48A on the connecting portion side of the pair of elastic pieces 31 and 32 is formed as a main-body-side elastically deformable portion 46.

The cord through bar 51 is provided on an outer surface of the lateral wall 14 of the main body 10 at a position near the upper wall 12 with a gap between the cord through bar 51 and the lateral wall 14. Strings 102 and 103 are inserted in the gap between the cord through bar 51 and the lateral wall 14 and the cords 102 and 103 are secured to an attached body such as a garment, thereby securing the cord stopper 6 to the attached body.

In the arrangement, when the operating body 20 is inserted in the main body 10, the pair of elastic pieces 31 and 32 is elastically deformed. Then, as shown in FIGS. 16 and 17, the division 48A on the connecting portion side of the pair of elastic pieces 31 and 32 divided by the slit 47 (the main-body-side elastically deformable portion 46) is formed so as to have a narrower width than that of the other division 48B, the division 48A is elastically deformed in directions different from those of the pair of elastic pieces 31 and 32. In other words, the slit 47 expands, thereby expanding the second opening 17.

Accordingly, since the pair of elastic pieces 31 and 32 is elastically deformed and the main-body-side elastically deformable portion 46 that is elastically deformable relative to the division 48B is provided, even the main body 10 can have elastic deformability. Hence, not only the accommodated-portion-side elastically deformable portion 26 but also the main-body-side elastically deformable portion 46 can be elastically deformed and have great elastic deformability. Thus, the dimension of the operating body 20 in the operation direction can be small while ensuring the holding force relative to the cord.

Since the division 48A on the connecting portion side of the pair of elastic pieces 31 and 32 (the main-body-side elastically deformable portion 46) is deformed, force concentrated on the connecting portion of the pair of elastic pieces 31 and 32 can be dispersed by the division 48A (the main-body-side elastically deformable portion 46) when the operating body 20 is inserted in the main body 10. Thereby, damage on the connecting portion of the pair of elastic pieces 31 and 32 can be avoided. This feature also functions as an advantage in manufacturing of the pair of elastic pieces 31 and 32 since it is not necessary to form the root portions of the pair of elastic pieces 31 and 32 (the connecting portions between the pair of elastic pieces 31 and 32 and the main body 10) to be thick.

In addition, since the lateral wall 14 of the main body 10 is divided by the slit 47 and the division 48A on the connecting portion side of the pair of elastic pieces 31 and 32 out of the divided lateral wall 14 is provided as the main-body-side elastically deformable portion 46, the main-body-side elastically deformable portion 46 can be provided on the main body 10 side with a simple arrangement. Further, since the slit 47 is provided so as to extend across the substantially diagonal positions on the pair of facing lateral walls 14, the elastic deformability can be ensured while ensuring the strength of the main body 10.

Note that, in the sixth embodiment, the slit 47 may not be positioned at the substantially diagonal positions on the pair of facing lateral walls 14, but the slit 47 may be provided on both sides of the pair of facing lateral walls.

### Seventh Embodiment

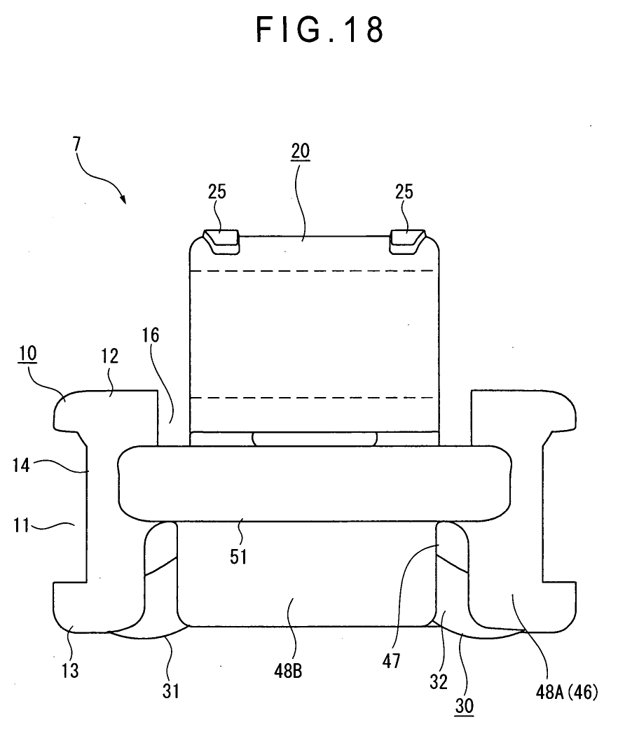

A seventh embodiment of the invention will be shown in FIG. 18. FIG. 18 is a front view of a cord stopper 7 of the seventh embodiment.

The cord stopper 7 of the seventh embodiment differs from the cord stopper 6 of the sixth embodiment in that the accommodated-portion-side elastically deformable portion 26 provided to the operating body 20 is omitted. In other words, herein the operating body 20 does not include the accommodated-portion-side elastically deformable portion 26 and the main-body-side elastically deformable portion 46 is provided only to the main body 10.

With such an arrangement, an object of the invention can be obtained.

### [Modifications]

The invention is not limited to the above-described embodiments but also includes modification and improvements as long as an object of the invention can be achieved.

In the above-described embodiments, the main body 10, the operating body 20 and the elastic body 30 are formed as an integral molding from a common resin material. However, the arrangement is not limited thereto. For example, the main body 10 and the operating body 20 may be formed with resin and a tip end of a metal plate spring may be integrally embedded as an elastic body.

As another example, when the main body 10 and the operating body 20 are resin molded, a plate spring may be set in a die in advance and a resin material is filled and solidified therein, thereby integrally forming the main body 10 and the operating body 20 with the plate spring molded.

As another example, the main body 10, the operating body 20 and the elastic body 30 may be made as a separate component and subsequently combined to form the cord stopper 1, 2, 3 and 4.

In the above-described embodiments, the main body 10 and the operating body 20 are formed in a rectangular cylindrical shape. However, the shape is not limited thereto but may be any. For example, the shape may be circular cylindrical. Further, the shape may not be cylindrical. The shape may be any as long as the first cord insertion hole 11 and the second cord insertion hole 21 are provided.

In the above-described embodiments, the accommodated-portion-side elastically deformable portion 26 is formed on the connecting portions of the operating body 20 to which the tip ends of the elastic pieces 31, 32 and 33 of the elastic body 30 are connected. In other words, the accommodated-portion-side elastically deformable portion 26 is provided from the lower wall 23 to the lateral walls 24 of the operating body 20. However, the position of the accommodated-portion-side elastically deformable portion 26 may be on the lateral walls 24 of the operating body 20 or from the lateral walls 24 to the upper wall 22.

Specifically, in order to form the accommodated-portion-side elastically deformable portion 26, the depth of the slits 27 in the operating body 20 needs to be large enough for the accommodated-portion-side elastically deformable portion 26 to be elastically deformed, so that the slits 27 may be formed in a portion of the lateral walls 24 or formed so as to extend from the lateral walls 24 to the upper wall 22 depending on requirements.

In the above-described embodiments, the accommodated-portion-side elastically deformable portion 26 is formed by the plurality of divisions 28A, 28B, 28C and 28AB divided by one or two slits 27. However, the arrangement is not limited thereto. In the above-described embodiments, the main-body-side elastically deformable portion 46 is the division 48A that is formed by dividing the lateral walls 14 by the slit 47. However, the arrangement is not limited thereto. That is to say, any other arrangement may be employed as long as the main-body-side elastically deformable portion 46 can be deformed at the same time when the elastic body 30 is elastically deformed and the dimension of the operating body 20 in the operation direction can be small.

In the above-described embodiments, the elastic body 30 is formed by the elastic pieces 31, 32 and 33 obliquely extending along a penetration direction of the first cord insertion hole 11 and the second cord insertion hole 21. However, the elastic body 30 may be an elastic piece obliquely extending in a direction intersecting with (specifically orthogonal to) the penetration direction of the first cord insertion hole 11 and the second cord insertion hole 21.

In the above-described embodiments, one cord 101 is held but two cords or three or more cords may be held. Further, the shape of the cord 101 is not limited to a round shape but may be flat or any other shape.

The priority applications Number JP2006-138514 and Number JP2007-062044 upon which this patent application is based are hereby incorporated by reference.

What is claimed is:

1. A cord stopper, comprising:
a main body including a first cord insertion hole;
an operating body including: an accommodated portion that can be accommodated in the main body; and a second cord insertion hole that is provided to the accommodated portion and can communicate with the first cord insertion hole; and
an elastic body that connects the main body and the operating body and biases the operating body in a direction in which the first cord insertion hole is displaced from the second cord insertion hole and in a direction in which the operating body protrudes from the main body, wherein
the accommodated portion is connected to the elastic body, and
an elastically deformable portion is provided to at least one of the accommodated portion and the main body, the elastically deformable portion being elastically deformable at the same time when the elastic body is elastically deformed.

2. The cord stopper according to claim 1, wherein
the accommodated portion includes a cord accommodating portion that accommodates a cord.

3. The cord stopper according to claim 1, wherein
the accommodated portion is provided with the accommodated-portion-side elastically deformable portion such that the accommodated-portion-side elastically deformable portion continuously extends from a protruding end surface of the operating body, the protruding end surface of the operating body protruding from the main body.

4. The cord stopper according to claim 1, wherein
the elastic body is elastically deformed in a direction in which the operating body moves, and
the accommodated-portion-side elastically deformable portion is elastically deformed in a different direction from that of the elastic body.

5. The cord stopper according to claim 4, wherein
the accommodated-portion-side elastically deformable portion can be elastically deformed in an expanding direction when an external force is applied on the operating body.

6. The cord stopper according to claim 1, wherein
the main body is provided with a first opening for accommodating the operating body in the main body, and
a wall facing the first opening is provided with a second opening for accommodating the elastic body in the main body.

7. The cord stopper according to claim 6, wherein
the main body is provided with the main-body-side elastically deformable portion that can be elastically deformed in a direction in which the second opening expands when the elastic body is elastically deformed, the main-body-side elastically deformable portion disposed in the vicinity of a connecting portion of the elastic body.

8. The cord stopper according to claim 7, wherein
the main body includes: a first wall in which the first opening is formed; a second wall in which the second opening is formed; and a pair of third walls that faces each other and connects the first wall and the second wall, the main body formed in a cylindrical shape having the first cord insertion hole inside,
each of the pair of third walls is provided with a slit of which one end reaches the second opening and the other end is near the first opening, the slit formed on a connecting portion side of the elastic body in a hole direction of the first cord insertion hole, and
a division on the connecting portion side of the elastic body out of the pair of third walls divided by each slit is provided as the main-body-side elastically deformable portion.

9. The cord stopper according to claim 8, wherein
the slit is provided in each of the pair of third walls that faces each other such that each slit is diagonal to each other.

10. The cord stopper according to claim 1, wherein
the elastic body is provided between a wall portion of the main body and an end surface opposite to a protruding end surface of the operating body, the protruding end surface of the operating body protruding from the main body, the wall portion facing the end surface, and
the elastic body includes an elastic piece provided so as to be slant as extending from the wall portion of the main body to the operating body.

11. The cord stopper according to claim 1, wherein
the elastic body is provided between a wall portion of the main body and an end surface opposite to a protruding end surface of the operating body, the protruding end surface of the operating body protruding from the main body, the wall portion facing the end surface, and
the elastic body includes a pair of elastic pieces provided so as to extend from remote positions on the wall portion of the main body, approach to each other as extending toward the operating body, intersect each other and further extend while becoming farther from each other.

12. The cord stopper according to claim 10, wherein
the accommodated-portion-side elastically deformable portion is formed by a plurality of divisions into which the accommodated portion is divided in a hole direction of the second cord insertion hole by slits having a depth reaching the second cord insertion hole, and
the elastic piece is connected to at least one of the divisions.

13. The cord stopper according to claim 11, wherein
the accommodated-portion-side elastically deformable portion is formed by a plurality of divisions into which the accommodated portion is divided in a hole direction of the second cord insertion hole by slits having a depth reaching the second cord insertion hole, and
the elastic piece is connected to at least one of the divisions.

14. A cord stopper, comprising: a main body having a first cord insertion hole; an operating body accommodated in the main body; and an elastic body biasing the operating body in a direction in which the operating body is protruded from the main body, wherein
the main body and the operating body are connected each other by the elastic body,
the main body includes at least one opening that is in communication with the first cord insertion hole,
the operating body includes a second cord insertion hole that can communicate with the first cord insertion hole and an accommodated-portion-side elastically deformable portion that is provided to the second cord insertion hole and connected to the elastic body, the accommodated-portion-side elastically deformable portion elastically deformable at the same time when the elastic body is elastically deformed,
the accommodated-portion-side elastically deformable portion is formed by a plurality of divisions into which the second cord insertion hole is divided in a hole direction of the second cord insertion hole by slits having a depth enough to reach the second cord insertion hole,
the elastic body is provided between a wall portion of the main body and an end surface opposite to a protruding end surface of the operating body, the protruding end surface of the operating body protruding from the main body, the wall portion facing the end surface,
the elastic body includes a pair of elastic pieces provided so as to extend from remote positions on the wall portion of the main body, approach to each other as extending toward the operating body, and
tip ends of the elastic pieces are connected with at least one of the divisions out of the divisions.

15. The cord stopper according to claim 14, wherein
the main body includes: a first wall; a second wall facing the first wall; and a pair of third walls that faces each other and connects the first wall and the second wall, the main body formed in a cylindrical shape having the first cord insertion hole inside,
the first wall is provided with a first opening for accommodating the operating body in the main body,
the second wall is provided with a second opening for accommodating the elastic body in the main body,
each of the pair of third walls is provided with a slit of which one end reaches the second opening and the other end is near the first opening, the slit formed on the connecting portion side of the elastic body in a hole direction of the first cord insertion hole, and
a division on the connecting portion side of the elastic body out of the pair of third walls divided by the slit is provided as a main-body-side elastically deformable portion that can be elastically deformed at the same time when the elastic body is elastically deformed.
